(19) United States
(12) Patent Application Publication
(10) Pub. No.: US 2013/0027263 A1
(43) Pub. Date: Jan. 31, 2013

(54) ANTENNA APPARATUS

(71) Applicants: Katsumi Gocho, Shizuoka-ken (JP); Hiroki Mochizuki, Shizuoka-ken (JP)

(72) Inventors: Katsumi Gocho, Shizuoka-ken (JP); Hiroki Mochizuki, Shizuoka-ken (JP)

(73) Assignee: TOSHIBA TEC KABUSHIKI KAISHA, Tokyo (JP)

(21) Appl. No.: 13/554,024

(22) Filed: Jul. 20, 2012

(30) Foreign Application Priority Data
Jul. 29, 2011 (JP) 2011-166747

(51) Int. Cl. H01Q 13/20

(52) U.S. Cl. 343/784

(57) ABSTRACT

According to one embodiment, an antenna device includes a leaky coaxial cable, an electrical device and a cover. The cover which is formed with a slender internal space having a first and second ends in the length direction and a first and second vent holes that respectively connect the internal space with the outside at each of the neighbourhood of the first and second ends, and houses the leaky coaxial cable and the electrical devices in the internal space.

### CROSS-REFERENCE TO RELATED APPLICATION

This application is based upon and claims the benefit of priority from Japanese Patent Application No. 2011-166747, filed Jul. 29, 2011, the entire contents of which are incorporated herein by reference.

### FIELD

Embodiments described herein relate to an antenna apparatus.

### BACKGROUND

The applicant has conceived a system which provides a spot service for a wireless communication using a vertical antenna apparatus equipped with a slender cover in which a leaky coaxial cable is housed.

Moreover, an electrical device for providing an additional service, such as the diffusion of aroma or ions, is carried in the antenna apparatus.

### BRIEF DESCRIPTION OF THE DRAWINGS

FIG. 1 is a cubic diagram showing a wireless communication machine involved in the first embodiment;

FIG. 2 is a sectional diagram showing one part of the wireless communication machine involved in the first embodiment;

FIG. 3 is a sectional diagram showing one part of a wireless communication machine involved in the second embodiment.

### DETAILED DESCRIPTION

According to one embodiment, an antenna device includes a leaky coaxial cable, an electrical device and a cover. The cover which is formed with a slender internal space having a first and second ends in the length direction and a first and second vent holes that respectively connect the internal space with the outside at each of the neighbourhood of the first and second ends, and houses the leaky coaxial cable and the electrical devices in the internal space.

Embodiments of the present invention are described below with reference to accompanying drawings.

### The First Embodiment

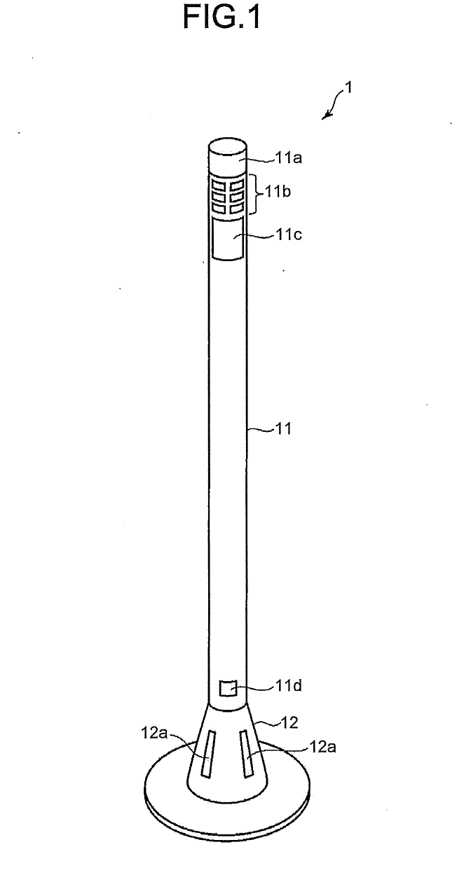

FIG. 1 is a cubic diagram showing an antenna apparatus 1 involved in the first embodiment.

The antenna apparatus 1 includes a cover 11 and a support table 12.

The cover 11 takes the shape of a slender cylinder. A light-giving window 11a, a vent hole set 11b and a display window 11c are arranged at one end of the cover 11A. A sensor window 11d is arranged at the other end of the cover 11. Light transmits through the light-giving window 11a. The vent hole set 11b is an element having a plurality of vent holes thereon. Each vent hole of the vent hole set 11b runs through the cover 11 so as to connect the internal space of the cover 11 with the outside. The display window 11c is a transparent window. Infrared rays transmit through the sensor window 11d. Further, the light-giving window 11a, the vent hole set 11b, the display window 11c and the sensor window 11d can be freely changed in both position and shape.

The support table 11 has a flat bottom side that is connected with the bed surface of the antenna apparatus 1 at a setting position. In order to make the length direction of the cover 11 substantially face a direction orthogonal to the bottom side of the support table 12, the support table 12 is provided with the end part of the sensor window 11d of the cover 11. That is, if the bed surface is a substantially horizontal plane, the support table 12 supports the cover 11 with its length direction substantially facing the vertical direction. The support table 12 has a plurality of slot-shaped vent holes 12a. In this embodiment, the support table 12 has four uniformly-spaced vent holes 12a. The vent holes 12a are changeable in shape and number.

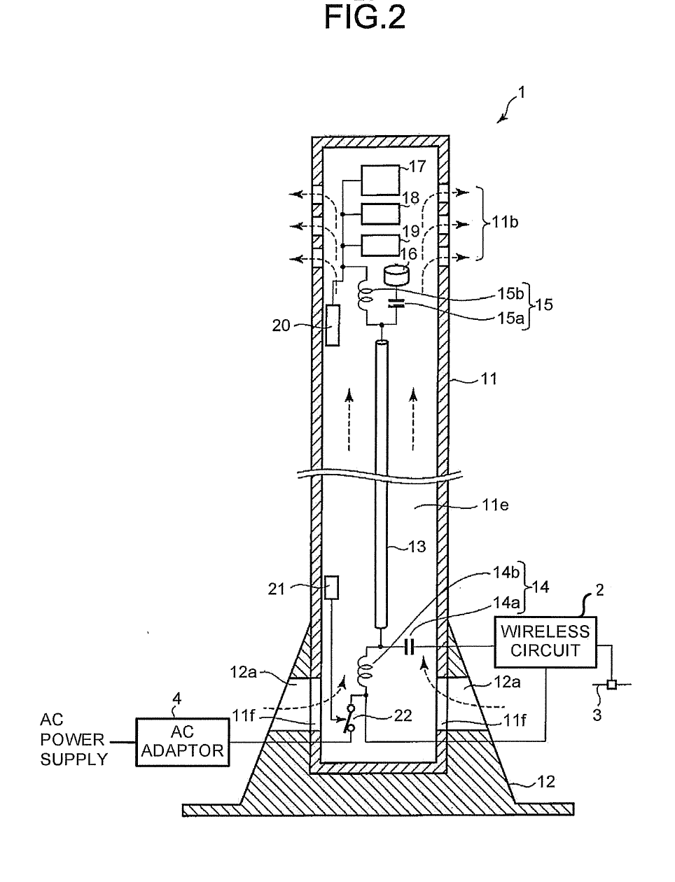

FIG. 2 is a cross-section diagram showing one part of the antenna apparatus 1. In addition, the members shown in FIG. 2 identical to those shown in FIG. 1 are represented by the same reference symbols.

FIG. 2 shows a longitudinal section of the cover 11 and the support table 12. As shown in FIG. 2, the cover 11 is hollow and has a slender internal space 11e. The light-giving window 11a and the sensor window 11d are not shown in FIG. 2. In addition, the cover 11 is provided with elements (not shown in FIG. 2) for supporting the components arranged in the cover 11.

The cover 11 have vent holes 11a that are equal in number to the vent holes 12a. The vent holes 11f and the vent holes 12a are formed in pairs. Each pair of vent hole 11f and vent hole 12a are connected so that the pair of vent hole 11f and vent hole 12a make up a vent hole for connecting the internal space 11e with the outside.

The cover 11 is provided with the vent holes of the vent hole set 11b on the part nearby one end of the internal space 11e and the vent holes formed by the vent holes 11f and the vent holes 12a on the part nearby the other end of the internal space 11e.

In addition to the cover 11 and the support table 12, the antenna apparatus 11 further includes a leaky coaxial cable (LCX) 13, bias-tees 14 and 15, a terminator 16, an LED indicator light 17, an aroma diffuser 18, a Picoion generator 19, a display 20, a human body sensor 21 and a power switch 23, each of which is arranged in the internal space 11e. The rough positions and the electrical connection state of the elements arranged inside the cover 11 are also shown in FIG. 2.

The LCX cable 13 transmits the high-frequency signal fed from one end to the other end, and synchronously emits, from a slot arranged in the middle of the LCX cable 13, part of the energy of the high-frequency signal as electric wave. Further, the LCX cable 13 transmits the high-frequency signal generated by the surrounding electromagnetic waves. The LCX cable 13 is arranged in a substantially linear form along the length direction of the cover 11.

The bias-tee 14 includes a capacitor 14a and an inductor 14b. One end of the capacitor 14a, one end of the inductor 14b and the first end of the LCX cable 13 are connected with each other. The other end of the capacitor 14a is connected with the high frequency signal input-output terminal of the wireless circuit 2. The direct-current voltage output by an AC adaptor 4 is fed at the other end of the inductor 15b through the power switch 22.

The bias-tee 15 includes a capacitor 15a and an inductor 15b. One end of the capacitor 15a, one end of the inductor 15b and the second end of the LCX cable 13 are connected with each other. The other end of the capacitor 15a is connected with the terminator 16. The other end of the inductor 15b is connected with the power terminals of the LED light 17, the aroma diffuser 18, the Picoion generator 19 and the display 20.

The terminator 16 is a resistor matching with the resistance at the second end of the LCX 13 to restrict the reflection of a high-frequency signal in the second end.

The LED indicator light 17, as a light source, includes an LED (Light Emitting Diode), and is arranged to transmit the light emitted by the LED to the outside of the cover 11 through the light-giving window 11a. By changing light-giving state, the LED indicator light 17 displays the action state of the antenna apparatus 1.

The aroma diffuser 18 generates an aromatic compound.

The Picoion generator 19 generates fine ions.

The display 20 displays various images, videos and words. With a display panel facing the display window 11c, the display 20 enables the images, videos and words displayed thereon to be seen from the outside of the cover 11 through the display window 11c. The display 20 may be a well-known display such as an LCD (Liquid Crystal Display).

The human body sensor 21 detects a person approaching the antenna apparatus using infrared rays and outputs a detection signal indicative of whether or not a person is detected. The human body sensor 21 may be replaced with a device which detects a person using, for example, ultrasonic waves rather than infrared rays.

The power switch 22 is switched on/off according to the detection signal output from the human body sensor 22.

The wireless circuit 2 is connected with such a communication line 3 as an LAN (Local Area Network) line. The wireless circuit 2 generates a high-frequency signal for wirelessly transmitting the transmission data sent through the communication line 3 from the LCX cable 13. Further, the wireless circuit 2 extracts the transmission data from the high-frequency signal generated by the LCX cable 13 and sends the extracted transmission data to the communication line 3. The wireless circuit 2 feeds, through the power switch 23, the AC adaptor 4 the direct-current voltage generated from an AC power supply, and is actuated by taking the direct-current voltage as an actuation voltage.

The actions of the antenna apparatus with the structure above are described below.

If a person approaching the antenna apparatus 1 is detected by the human body sensor 21, the power switch 22 is switched on. Thus, the wireless circuit 2 is fed with the direct-current voltage output by the AC adaptor 13 and then acts.

The high frequency signal output from the input-output terminal of the wireless circuit 2 flows through the capacitor 14a but not through the inductor 14b. On the other hand, the direct-current voltage output from the AC adaptor 4 flows through the inductor 14b but not through the capacitor 14a. In this way, a transmission signal in which the direct-current voltage is superposed with the high frequency signal is generated by the bias-tee 14. That is, the bias-tee 14 acts as a superposing circuit.

If fed with the transmission signal at the first end from the bias-tee 14, the LCX cable 13 transmits the transmission signal to the second end, and synchronously emits part of the energy of the high frequency signal contained in the transmission signal as electric wave. Further, the high frequency signal contained in the transmission signal that is not emitted as electric wave flows through the capacitor 15a in the bias-tee 15 and is stopped by the terminator 16. On the other hand, the high frequency signal generated in the LCX cable 13 from the electric wave around the LCX cable 13 flows through the capacitor 14a in the bias-tee 14, and is then provided to the input-output terminal of the wireless circuit 2. In this way, the wireless terminal nearby the antenna apparatus 1 may be connected with a communication line 3 through the antenna apparatus 1. That is, the antenna apparatus and the communication circuit 3 provide wireless access points.

The direct-current voltage contained in the transmission signal flows through the inductor 15b in the bias-tee 15 and is then provided to the power terminals of the LED light 17, the aroma diffuser 18, the Picoion generator 19 and the display 20 so that the LED light 17, the aroma diffuser 18, the Picoion generator 19 and the display 20 can act. In this way, the bias-tee 15 separates the high frequency signal from the direct-current voltage contained in the transmission signal and therefore acts as a separation circuit.

The high frequency signal is stopped by the inductors 14b and 15b and is therefore not provided to the power terminals of the wireless circuit 2, the LED indicator light 17, the aroma diffuser 18, the Picoion generator 19 and the display 20 or the output terminal of the AC adaptor 4. Thus, the voltage supplied to the wireless circuit 2, the LED indicator light 17, the aroma diffuser 18, the Picoion generator 19 and the display 20 maintains invariable, which eliminates an abnormality caused by a power supply variation due to the high frequency signal. Besides, no high frequency signal is input to the output terminal of the AC adaptor 4, thus eliminating the hazards caused by the generation of a high frequency signal by the AC adaptor 4.

The LED light 17, the aroma diffuser 18, the Picoion generator 19 and the display 20 radiate heat in the actions above. If the temperature in the internal space 11e rises due to the heat radiation of the electrical devices, an ascending air current resulting from convection is generated in the internal space 11e. As a result, an air current indicated by the dotted arrow shown in FIG. 2 is generated which flows into the internal space 11e through the vent holes 12a and 11e, then flows in the internal space 11e, and finally flows out of the internal space 11e through vent hole set 11b.

In accordance with the antenna apparatus 1 above, the heat energy in the internal space 11e is dissipated to the outside by the air current generated in the internal space 11e in the way described above, thus preventing the generation of an over-high temperature in the internal space 11e.

Air containing the compound generated by the aroma diffuser 18 and the ions generated by the Picoion generator 19 is effectively released to the outside of the cover 11 by the air current through the vent hole set 11b.

### The Second Embodiment

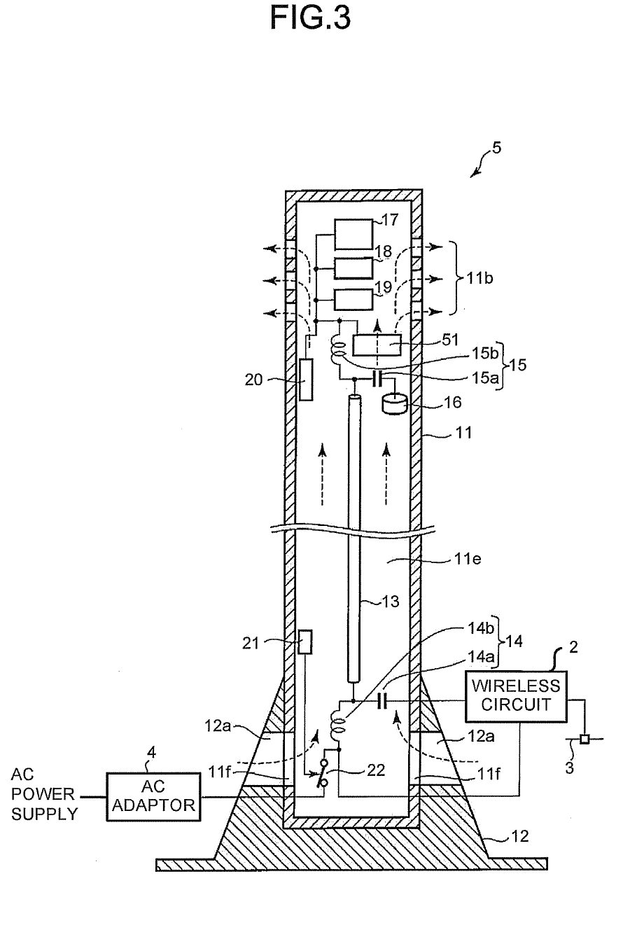

FIG. 3 is a sectional diagram showing one part of an antenna apparatus 5 involved in the second embodiment. In addition, the members shown in FIG. 3 identical to those shown in FIG. 1 and FIG. 2 are represented by the same reference symbols.

The antenna apparatus 5 is different from the antenna apparatus 1 in having a fan 51.

The fan 51 is arranged in the internal space 11e, actuated by the direct-current voltage generated by the inductor 15b in the bias-tee 15, and generates an air current from the bottom of the internal space 11e to the top of the internal space 11e.

The actions of the antenna apparatus 5 with the structure above are described below.

When the power switch 22 is switched on as a person approaches the antenna apparatus 5, the LED light 17, the aroma diffuser 18, the Picoion generator 19 and the display 20 act, and the fan 51 acts as well. The fan 51 generates an air current from the bottom of the internal space 11e to the top of the internal space 11e. As a result, an air current indicated by the dotted arrow shown in FIG. 3 is generated which flows into the internal space 11e through the vent holes 12a and 11e, then flows in the internal space 11e, and finally flows out of the internal space 11e through vent hole set 11b.

In accordance with the antenna device 5 above, the heat in the internal space 11e is dissipated to the outside by the air current generated in the internal space 11e in the way described above, thus preventing the generation of an over-high temperature in the internal space 11e. Moreover, in the antenna apparatus 5, due to the air current generated by the fan 51, a stronger air current can be indeed generated by the antenna apparatus, and the internal space 11e can be indeed cooled by the antenna apparatus.

In accordance with the antenna apparatus 5, the feed cable for supplying an actuation voltage to the LED indicator light 17, the aroma diffuser 18, the Picoion generator 19, the display 20 and the fan 51 is not arranged parallel to the LCX cable 13, which provides an orderly internal space 11e when compared with the situation in which the feed cable is arranged parallel to the LCX cable 13.

In the antenna apparatus 1, the supply of a direct-current voltage to the bias-tee 14 is stopped when there is no person nearby the antenna apparatus, thus lowering power consumption. Moreover, in this embodiment, the LED indicator light 17, the aroma diffuser 18, the Picoion generator 19 and the display 20 are all devices that provide services for the person close to the wireless communication machine 1 and stop working when there is no person to be served. Moreover, as the LED indicator light 17, the aroma diffuser 18, the Picoion generator 19 and the display 20 radiate no heat in a non-working state, the working of the fan 51 can be stopped in this case.

This embodiment may be embodied in the following forms.

Vent holes 11f may be arranged on the part of the support table 12 that is not covered by the cover 11, or the vent holes 12a may not be arranged.

The electrical devices may not include one part of the LED indicator light 17, the aroma diffuser 18, the Picoion generator 19 and the display 20 or may include various other elements rather than those above. That is, the electrical devices actuated by the direct-current voltage separated by the bias-tee 15 may include at least one of the LED indicator light 17, the aroma diffuser 18, the Picoion generator 20, the display 20 and the devices different from those above.

The fan 51 may be fed with a direct-current voltage by a feed cable different from the LCX cable 13.

A direct-current voltage may be fed to the fan 51 without using the power switch 22.

The human body sensor 21 and the power switch 22 may not be arranged on the antenna apparatus 5.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An antenna device, comprising:
a leaky coaxial cable;
an electrical device; and
a cover, which is formed with a slender internal space having a first and second ends in the length direction and a first and second vent holes that respectively connect the internal space with the outside at each of the neighbourhood of the first and second ends, and houses the leaky coaxial cable and the electrical devices in the internal space.

2. The antenna apparatus according to claim 1, further comprising:
a support table configured to support the cover in such as manner that the length direction of the cover substantially faces the vertical direction.

3. The antenna apparatus according to claim 1, further comprising:
a fan configured to generate an air current in the internal space.

4. The antenna apparatus according to claim 2, further comprising:
a fan configured to generate an air current in the internal space.

5. The antenna apparatus according to claim 3, further comprising:
an superposing circuit configured to superpose a high frequency signal with a direct-current voltage and supply a transmission signal as the superposition result to the first end of the leaky coaxial cable; and
a separation circuit that is connected with the second end of the leaky coaxial cable and separates the high frequency signal and the direct-current voltage from the transmission signal transmitted through the leaky coaxial cable, wherein
the fan is actuated by the direct-current voltage separated by the separation circuit.

6. The antenna apparatus according to claim 4, further comprising:
an superposing circuit configured to superpose a high frequency signal with a direct-current voltage and supply a transmission signal as the superposition result to the first end of the leaky coaxial cable; and
a separation circuit that is connected with the second end of the leaky coaxial cable and separates the high frequency signal and the direct-current voltage from the transmission signal transmitted through the leaky coaxial cable, wherein
the fan is actuated by the direct-current voltage separated by the separation circuit.

7. The antenna apparatus according to claim 5, further comprising:
a human body sensor arranged to detect a person approaching; and
a switch arranged to switch off the input of the direct-current voltage to the superposing circuit when the person approaching is not detected by the human body sensor.

8. The antenna apparatus according to claim 6, further comprising:
a human body sensor arranged to detect a person approaching; and
a switch arranged to switch off the input of the direct-current voltage to the superposing circuit when the person approaching is not detected by the human body sensor.
